(19) United States
(12) Patent Application Publication
(10) Pub. No.: US 2023/0410384 A1
(43) Pub. Date: Dec. 21, 2023

(54) AUGMENTED REALITY HIERARCHICAL DEVICE LOCALIZATION

(71) Applicant: Design Reactor, Inc., Palo Alto, CA (US)

(72) Inventors: Darius Pajouh, Palo Alto, CA (US); Adam Benson, Palo Alto, CA (US)

(21) Appl. No.: 18/335,839

(22) Filed: Jun. 15, 2023

Related U.S. Application Data
(60) Provisional application No. 63/352,442, filed on Jun. 15, 2022.

(51) Int. Cl. G06T 11/00; G06T 7/73

(52) U.S. Cl. CPC G06T 11/00; G06T 7/73; G06T 2207/10016

(57) ABSTRACT

Provided is a method including: recording, by a computer system, a video of a macro-area of a physical environment to a micro-area of the physical environment; mapping, by the computer system, a plurality of feature points in the micro-area of the environment; positioning, by the computer system and in response to a user input, an augmented reality model at a location in the physical environment in the mapped micro-area; and storing, by the computer system, the video, the mapped micro-area, and the location in association with the augmented reality model in a database.

### CROSS-REFERENCE TO RELATED APPLICATIONS

This application claims benefit of U.S. Provisional Patent Application 63/352,442, titled “Augmented Reality Hierarchical Device Localization,” filed 15 Jun. 2022. The entire content of the aforementioned patent filing is hereby incorporated by reference.

### BACKGROUND

### 1. Field

The present disclosure relates generally to augmented reality and, more specifically, to hierarchical device localization in augmented reality.

### 2. Description of the Related Art

Augmented reality has experienced rapid uptake in recent years. Examples include various types of games and image-modification applications on mobile phones, as well as the same implemented on head-mounted augmented reality displays. Often, augmented reality experiences draw upon various assets, such as three-dimensional models or two-dimensional models and associated textures to be inserted into the physical environment the user is viewing through the augmented reality display.

### SUMMARY

The following is a non-exhaustive listing of some aspects of the present techniques. These and other aspects are described in the following disclosure.

Some aspects include a method including obtaining, by a computer system, first visual content of a macro-area of a physical environment that includes a micro-area of the physical environment; obtaining, by the computer system, first position information associated with an imaging sensor used to capture the first visual content, wherein the first position information is captured during capturing of the first visual content; determining, by the computer system, a first plurality of feature points in the micro-area of the physical environment captured by the imaging sensor; obtaining, by the computer system, a mapping of a first augmented reality model at a location in the physical environment via a display such that the first augmented reality model is associated with the first plurality of feature points in the micro-area; and storing, by the computer system, the first visual content, the first position information, the first plurality of feature points, the first augmented reality model, and the mapping of the first augmented reality model and the first plurality of feature points in a database.

Some aspects include a tangible, non-transitory, machine-readable medium storing instructions that when executed by a data processing apparatus cause the data processing apparatus to perform operations including the above-mentioned process.

Some aspects include a system, including: one or more processors; and memory storing instructions that when executed by the processors cause the processors to effectuate operations of the above-mentioned process.

Some aspects include a method including causing, by a computer system and in response to a localization condition being satisfied, visual content of a macro-area of a physical environment that includes a micro-area of the physical environment to be displayed on a display of an augmented reality device; obtaining, by the computer system, a plurality of feature points of the physical environment captured by the augmented reality device; detecting, by the computer system, a set of feature points from the plurality of feature points that indicates a mapped micro-area of the physical environment, wherein the mapped micro-area is associated with an augmented reality model; localizing, by the computer system, the augmented reality device with the mapped micro-area; and causing, by the computer system, the augmented reality model to be displayed in the display of the augmented reality device according to the mapped micro-area of the set of feature points and a location of the augmented reality model mapped to the set of feature points.

Some aspects include a tangible, non-transitory, machine-readable medium storing instructions that when executed by a data processing apparatus cause the data processing apparatus to perform operations including the above-mentioned process.

Some aspects include a system, including: one or more processors; and memory storing instructions that when executed by the processors cause the processors to effectuate operations of the above-mentioned process.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1A is a schematic view illustrating an embodiment of an augmented reality hierarchical device localization system, in accordance with some embodiments of the present disclosure;

FIG. 1B is a schematic view illustrating an embodiment of the augmented reality hierarchical device localization system, in accordance with some embodiments of the present disclosure;

FIG. 2 is a schematic view illustrating an embodiment of an augmented reality device used in the augmented reality hierarchical device localization system of FIGS. 1A and 1B, in accordance with some embodiments of the present disclosure;

FIG. 3 is a schematic view illustrating an embodiment of a server device used in the augmented reality hierarchical device localization system of FIGS. 1A and 1B, in accordance with some embodiments of the present disclosure;

FIG. 4 is a flow chart illustrating an embodiment of a method of establishing a hierarchical device localization for augmented reality, in accordance with some embodiments of the present disclosure;

FIGS. 5A-5C are a series of screenshots of an embodiment of an augmented reality device establishing a hierarchical device localization for augmented reality during the method of FIG. 4, in accordance with some embodiments of the present disclosure;

FIG. 6 is a flow chart illustrating an embodiment of a method of hierarchical device localization for augmented reality, in accordance with some embodiments of the present disclosure; and

FIGS. 7A-7F are a series of screenshots of an embodiment of an augmented reality device hierarchically being localized for augmented reality during the method of FIG. 6, in accordance with some embodiments of the present disclosure;

FIGS. 8A-8F are a series of screenshots of an embodiment of an augmented reality device hierarchically being localized for augmented reality during the method of FIG. 6, in accordance with some embodiments of the present disclosure;

FIG. 9 is a block diagram of an example of a computing system with which the present techniques may be implemented, in accordance with some embodiments of the present disclosure.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the fields of augmented reality and device localization. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

Augmented reality (AR) developer applications (e.g., ARCore or ARKit) are used to build augmented reality experiences for various operating systems and augmented reality devices. Generally, the AR developer application tracks the position of the augmented reality device as it moves through an environment and builds its own understanding of the real world. The AR developer application uses motion tracking technology via one or more cameras included on the augmented reality device to identify interesting points, called feature point, and tracks how those points move over time. With a combination of the movement of these feature points and readings from the positioning sensors (e.g., an inertial measurement unit (IMU)) included in the augmented reality device, the AR developer application determines both the position and orientation of the augmented reality device as it moves through its physical environment. As the augmented reality device moves through the physical environment, the AR developer application may use a process called simultaneous localization and mapping (SLAM) to understand where the augmented reality device is relative to the physical environment. The captured feature points are used in the SLAM process to compute a change in location of the augmented reality device, the visual information, as well as the inertial measurements that are used to estimate a pose (position and orientation) of the camera relative to the physical environment. The AR developer application aligns a pose of a virtual camera that renders the augmented reality models with the pose of the physical camera included on the augmented reality device to render the augmented reality model from the correct perspective and overlaid on top of the image obtained from the physical camera making the augmented reality models from the correct perspective and making the augmented reality model appear to be part of the physical environment.

However, poses can change as the AR developer application improves its understanding of the physical environment. As such, when placing an augmented reality model in the physical environment, an anchor is often defined to ensure that the AR developer application tracks the augmented reality model over time. Otherwise, without the anchor, an augmented reality model may appear to drift away from where it was placed in the physical environment over time. As such, an augmented reality model is attached to an anchor in the physical environment (e.g., by capturing feature points of the anchor and mapping the feature points of the augmented reality model to the feature points of the anchor). When the same augmented reality device that placed the augmented reality object or a different augmented reality device comes into the physical environment and is instructed to view the augmented reality models, that augmented reality device needs to capture the feature points of the anchor to align the pose of the camera of the augmented reality device to the pose of the virtual camera that renders the augmented reality model. However, the anchor is typically difficult to find as it is often of a “micro-view” of the physical environment. For example, the anchor may be of some relatively small physical object in the physical environment to achieve the best mapping between the anchor's feature points and the augmented reality model. Thus, in a physical environment that is relatively large, finding the anchor, even if an image or a description of the anchor is provided to a user (e.g., machines that include artificial intelligence that utilizes computer vision or a human user), is cumbersome and time consuming.

Systems and methods of the present disclosure provide augmented reality hierarchical device localization. When an augmented reality model is anchored to the physical environment to feature points of a micro-area (e.g., an anchor), the user may record a video of a macro-area of a physical environment to a micro-area of the physical environment. The macro-area may provide more information about the physical environment to the user or to an artificial intelligence program that uses computer vision to determine the micro-area and anchors. The video may be recorded such that it zooms from the macro-area to the micro-area or provides a series of images as the augmented reality device moves through the physical environment from the macro-area to the micro-area. The micro-area may provide an anchor such that the feature points of the micro-area are attached to the feature points and pose of a placed augmented reality model in the physical environment.

When an augmented reality device is attempting to localize to view the augmented reality model that was placed, the augmented reality device may receive the video. In some embodiments, the video may be associated with a geolocation and the augmented reality device may receive the video in response to the geolocation of the augmented reality device satisfying a proximity condition (e.g., being within a predetermine threshold distance) with respect to the geolocation of the video. If a plurality of videos are received, the order in which those videos are displayed on the augmented reality device are based on the distance between the geolocation associated with the video and the geolocation associated with the augmented reality device. For example, the video associated with the nearest geolocation may be presented first on a graphical user interface displayed on a display of the augmented reality device. The video may be played on a display of the augmented reality device such that the user knows how to locate the micro-area from the macro-area. As the augmented reality device moves to the micro-area, the feature points of the physical environment may be captured until feature points of an anchor are discovered. The augmented reality device may localize to the anchor and one or more augmented reality models mapped to the anchor may be rendered in the physical environment displayed by the augmented reality device.

In other embodiments, a location of an augmented reality device may be determined. Based on the location of the augmented reality device, a first set of images may be provided to the augmented reality device. The images in the first set of images may include an anchor in a micro-area used to localize the augmented reality device. Each of the images of the first set of images may be associated with orientation information such as compass data from a compass in the augmented reality device or other orientation information provided by an IMU. When the orientation information associated with the augmented reality device satisfies a matching condition with the orientation information associated with an image of the first set of images, the augmented reality device may display the image on the display of the augmented reality device. The user may attempt to position the orientation and location of the augmented reality device to the orientation and location presented in the displayed image to capture the feature points of the anchor when localizing the augmented reality device. If the augmented reality device moves to a new location, a second set of images may be provided to the augmented reality device and displayed. As such, in various embodiments, the image displayed is based on positioning information that includes both orientation information and location information of the augmented reality device.

In some embodiments, the transition between images in the same set or images between different sets may be gradual. For example, a portion of a first image of a first set may be partially displayed in the display of the augment reality device while a portion of a second image of the first set is also displayed when the orientation of the augmented reality device is between the orientation condition associated with the first image and the orientation condition associated with the second image. Similarly, as the augmented reality device changes locations, a portion of a first image of a first set may be partially displayed in the display of the augment reality device while a portion of a first image of the second set is also displayed when the location of the augmented reality device is between the location condition associated with the first image of the first set and the location condition associated with the first image of the second set.

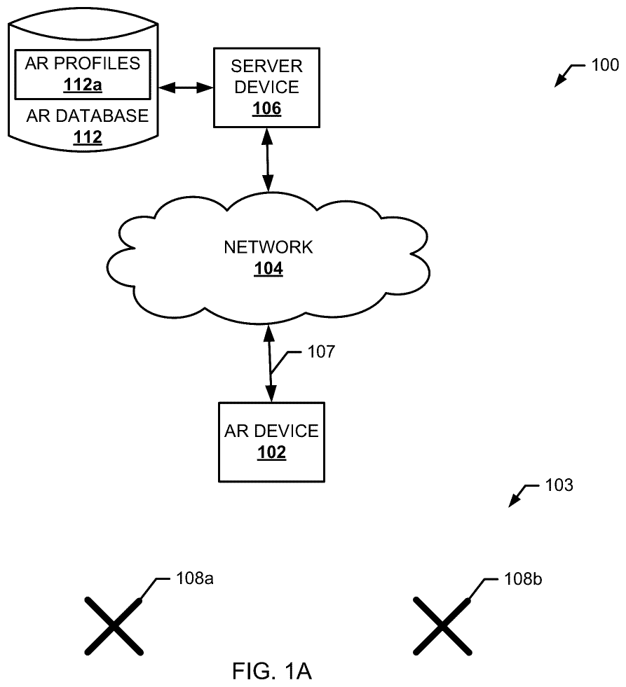

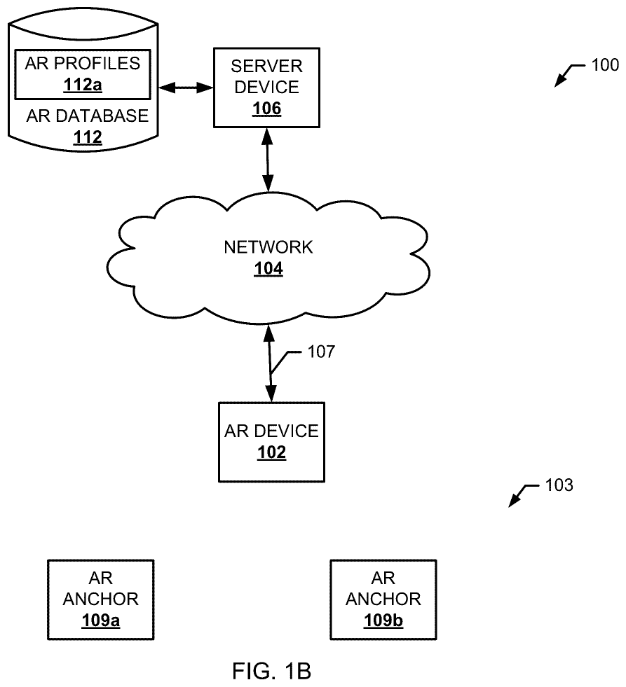

An embodiment of an augmented reality hierarchical device localization system 100 is illustrated in FIG. 1A. In the illustrated embodiment, the augmented reality hierarchical device localization system 100 includes an augmented reality device 102 provided in a physical environment 103. The physical environment 103 may be any indoor or outdoor space that may be contiguous or non-contiguous. For example, the physical environment may include a yard, a park, a stadium, a field, a mine site, a grocery store, a mall, or other spaces. The physical environment 103 may be defined by geofencing techniques that may include specific geographic coordinates such as latitude, longitude, or altitude, or operate within a range defined by a wireless communication signal. The physical environment 103 may include a plurality of locations of interest (LOI) such as a LOI 108a and a LOI 108b. The LOIs 108a and 108b may be locations that will include an anchor such that when the augmented reality device 102 localizes to the anchor, an augmented reality model may be rendered and positioned in the physical environment 103 that is provided in the display of the augmented reality device 102.

In various embodiments, the augmented reality device 102 is described as a mobile computing device such as a laptop/notebook, a tablet, a mobile phone, and a wearable (e.g., glasses, a watch, a pendant). However, in other embodiments, the augmented reality device 102 may be provided by desktop computers, servers, or a variety of other computing devices that would be apparent to one of skill in the art in possession of the present disclosure. The augmented reality device 102 may include communication units having one or more transceivers to enable augmented reality device 102 to communicate with field devices (e.g., IoT devices, beacons), other augmented reality devices, or a server device 106. As used herein, the phrase “in communication,” including variances thereof, encompasses direct communication or indirect communication through one or more intermediary components and does not require direct physical (e.g., wired or wireless) communication or constant communication, but rather additionally includes selective communication at periodic or aperiodic intervals, as well as one-time events.

For example, the augmented reality device 102 in the augmented reality hierarchical device localization system 100 of FIG. 1A may include first (e.g., relatively long-range) transceiver(s) to permit the augmented reality device 102 to communicate with a network 104 via a communication channel 107. The network 104 may be implemented by an example mobile cellular network, such as a long-term evolution (LTE) network or other third generation (3G), fourth generation (4G) wireless network, fifth generation (5G) wireless network, or future generation wireless networks. However, in some examples, the network 104 may be additionally or alternatively be implemented by one or more other communication networks, such as, but not limited to, a satellite communication network, a microwave radio network, or other communication networks.

The augmented reality device 102 additionally may include second (e.g., relatively short-range) transceiver(s) to permit augmented reality device 102 to communicate with IoT devices (e.g., beacons), other augmented reality devices, or other devices in the physical environment 103 via a different communication channel. In the illustrated example of FIG. 1A, such second transceivers are implemented by a type of transceiver supporting short-range (e.g., operate at distances that are shorter than the long-range transceivers) wireless networking. For example, such second transceivers may be implemented by Wi-Fi transceivers (e.g., via a Wi-Fi Direct protocol), Bluetooth® transceivers, infrared (IR) transceiver, and other transceivers that are configured to allow the augmented reality device 102 to intercommunicate via an ad-hoc or other wireless network.

The augmented reality hierarchical device localization system 100 also includes or may be in connection with a server device 106. For example, the server device 106 may include one or more servers, storage systems, cloud computing systems, or other computing devices (e.g., desktop computer(s), laptop/notebook computer(s), tablet computer(s), mobile phone(s), etc.). As discussed below, the server device 106 may be coupled to an augmented reality database 112 that is configured to provide repositories such as an augmented reality repository of augmented reality profiles 112a for various LOI within the physical environment 103. For example, the augmented reality database 112 may include a plurality of augmented reality profiles 112a that each includes a location identifier (e.g., a target coordinate), annotation content, augmented reality models, rendering instructions, object recognition data, mapping data, localization data, localization videos as well as any other information for providing an augmented reality experience to a display of the physical environment 103. While not illustrated in FIG. 1A, the augmented reality device 102 may be coupled to one or more local augmented reality databases that may include at least a portion of the augmented reality profiles 112a (e.g., that may include an augmented reality model) stored in the augmented reality database 112.

Referring now to FIG. 1B, an embodiment of the augmented reality hierarchical device localization system 100 of FIG. 1A is illustrated. However, the augmented reality hierarchical device localization system 100 of FIG. 1B includes augmented reality anchors (e.g., an augmented reality anchor 109a and an augmented reality anchor 109b) already positioned in the physical environment 103. The augmented reality anchor 109a or 109b may include any texture image files, three-dimensional models (e.g., polygon meshes), audio files, event handlers, and the like such as, for example, a three-dimensional map of the physical environment 103. The augmented reality hierarchical device localization system 100 of FIG. 1B may be configured to localize the augmented reality device 102 to an augmented reality model using the augmented reality anchors 109a or 109b, as discussed below.

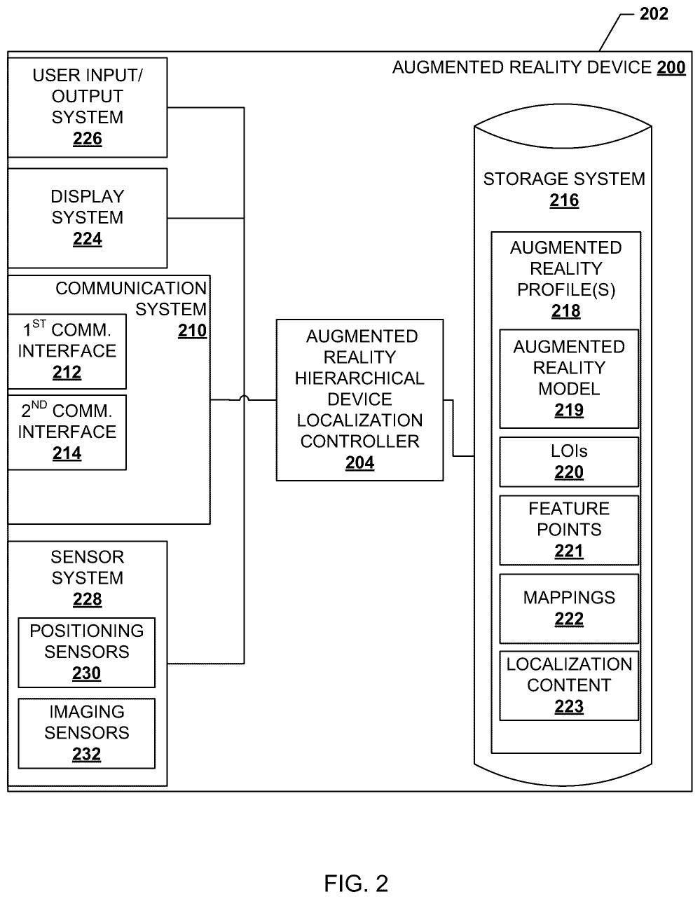

An embodiment of an augmented reality device 200 is illustrated in FIG. 2 that may be the augmented reality device 102 discussed above with reference to FIGS. 1A and 1B, and which may be provided by a mobile computing device such as a laptop/notebook computer, a tablet computer, a mobile phone, or a wearable computer. In the illustrated embodiment, the augmented reality device 200 includes a chassis 202 that houses the components of the augmented reality device 200. Several of these components are illustrated in FIG. 2. For example, the chassis 202 may house a processing system (not illustrated) and a non-transitory memory system (not illustrated) that includes instructions that, when executed by the processing system, cause the processing system to provide an augmented reality hierarchical device localization controller 204 that is configured to perform the functions of the augmented reality hierarchical device localization controller or the augmented reality devices discussed below.

The chassis 202 may further house a communication system 210 that is coupled to the augmented reality hierarchical device localization controller 204 (e.g., via a coupling between the communication system 210 and the processing system). The communication system 210 may include software or instructions that are stored on a computer-readable medium and that allow the augmented reality device 200 to send and receive information through the communication networks discussed above. For example, the communication system 210 may include a first communication interface 212 to provide for communications through the network 104 as detailed above (e.g., first (e.g., relatively long-range) transceiver(s)). In an embodiment, the first communication interface 212 may be a wireless antenna that is configured to provide communications with IEEE 802.11 protocols (Wi-Fi), cellular communications, satellite communications, other microwave radio communications or communications. The communication system 210 may also include a second communication interface 214 that is configured to provide direct communication with other user devices, sensors, storage devices, and other devices within the physical environment 103 discussed above with respect to FIGS. 1A and 1B (e.g., second (e.g., relatively short-range) transceiver(s)). For example, the second communication interface 214 may be configured to operate according to wireless protocols such as Bluetooth®, Bluetooth® Low Energy (BLE), near field communication (NFC), infrared data association (IrDA), ANT®, Zigbee®, Z-Wave® IEEE 802.11 protocols (Wi-Fi), and other wireless communication protocols that allow for direct communication between devices.

The chassis 202 may house a storage device (not illustrated) that provides a storage system 216 that is coupled to the augmented reality hierarchical device localization controller 204 through the processing system. The storage system 216 may be configured to store augmented reality profiles 218 in one or more augmented reality repositories. Each augmented reality profile 218 may include an augmented reality model 219, one or more LOIs 220, feature points 221, one or more virtual-to-physical environment mappings 222, or localization content 223. For example, the LOIs 220 may include a coordinate such longitude, latitude, altitude, or any other location information. The feature points 221 may include computer recognizable points in the physical environment 103 that is associated with the LOI 220 or the augmented reality model 219. The feature points 221 may be included in the virtual-to-physical environment mapping 222 that maps the augmented reality model 219 to the physical environment 103 and used to localize the augmented reality device 200 to the augmented reality model 219. The augmented reality model 219 may include a two-dimensional image/model, a three-dimensional image/model, annotation content, text, an audio file, a video file, a link to a website, an interactive annotation, or any other visual or auditory annotations that may be superimposed on or near a LOI(s) that the augmented reality model 219 is associated with in the physical environment 103 being reproduced on a display screen included on a display system 224 of the augmented reality device 200. The augmented reality model 219 may also include rendering instructions that provide instructions to the augmented reality device 200 as to how the augmented reality device 200 is to display the augmented reality model 219 via the display system 224. In addition, the storage system 216 may include at least one application that provides instruction to the augmented reality hierarchical device localization controller 204 when providing the augmented reality model 219 on a display system 224. In various embodiments, the localization content 223 may include visual content for directing a user to an anchor or localization location. For example, the localization content 223 may include video content and location information associated with the video content that directs a user from a macro-area of a physical environment to a micro-area of a physical environment that includes the LOI 220 or feature points 221 of an anchor. In other embodiments, the localization content 223 may include sets of images where each set is associated with a location and each image of the set is associated with an orientation.

In various embodiments, the chassis 202 also houses a user input/output (I/O) system 226 that is coupled to the augmented reality hierarchical device localization controller 204 (e.g., via a coupling between the processing system and the user I/O system 226). In an embodiment, the user I/O system 226 may be provided by a keyboard input subsystem, a mouse input subsystem, a track pad input subsystem, a touch input display subsystem, a microphone, an audio system, a haptic feedback system, or any other input/output subsystem that would be apparent to one of skill in the art in possession of the present disclosure. The chassis 202 also houses the display system 224 that is coupled to the augmented reality hierarchical device localization controller 204 (e.g., via a coupling between the processing system and the display system 224) and may be included in the user I/O system 226. In some embodiments, the display system 224 may be provided by a display device that is integrated into the augmented reality device 200 and that includes a display screen (e.g., a display screen on a laptop/notebook computing device, a tablet computing device, a mobile phone, AR glasses, or other wearable devices), or by a display device that is coupled directly to the augmented reality device 200 (e.g., a display device coupled to a desktop computing device by a cabled or wireless connection).

The chassis 202 may also house a sensor system 228 that may be housed in the chassis 202 or provided on the chassis 202. The sensor system 228 may be coupled to the augmented reality hierarchical device localization controller 204 via the processing system. The sensor system 228 may include one or more sensors that gather sensor data about the augmented reality device 200, a user of the augmented reality device 200, the physical environment 103 around the augmented reality device 200 or other sensor data that may be apparent to one of skill in the art in possession of the present disclosure. For example, the sensor system 228 may include positioning sensors 230 that may include a geolocation sensor (a global positioning system (GPS) receiver, a real-time kinematic (RTK) GPS receiver, or a differential GPS receiver), a Wi-Fi based positioning system (WPS) receiver, an accelerometer, a gyroscope, a compass, an inertial measurement unit (e.g., a six axis IMU), or any other sensor for detecting or calculating orientation, location, or movement that would be apparent to one of skill in the art in possession of the present disclosure. The sensor system 228 may include an imaging sensor 232 that may include an imaging sensor such as a camera, a depth sensing camera (for example based upon projected structured light, time-of-flight, a lidar sensor, or other approaches), other imaging sensors (e.g., a three-dimensional image capturing camera, an infrared image capturing camera, an ultraviolet image capturing camera, similar video recorders, or a variety of other image or data capturing devices that may be used to gather visual information from the physical environment 103 surrounding the augmented reality device 200). The sensor system 228 may include other sensors such as, for example, a beacon sensor, ultra-wideband sensors, a barometric pressure sensor, one or more biometric sensor, an actuator, a pressure sensor, a temperature sensor, an RFID reader/writer, an audio sensor, an anemometer, a chemical sensor (e.g., a carbon monoxide sensor), or any other sensor that would be apparent to one of skill in the art in possession of the present disclosure. While a specific augmented reality device 200 has been illustrated, one of skill in the art in possession of the present disclosure will recognize that augmented reality devices (or other devices operating according to the teachings of the present disclosure in a manner similar to that described below for the augmented reality device 200) may include a variety of components and/or component configurations for providing conventional computing device functionality, as well as the functionality discussed below, while remaining within the scope of the present disclosure as well.

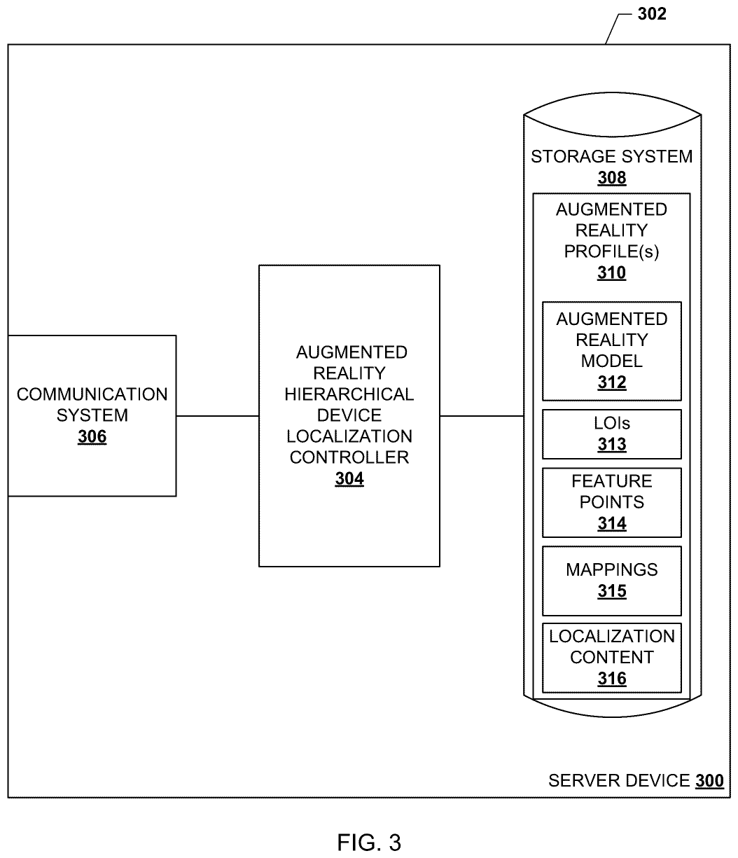

An embodiment of a server device 300 is illustrated in FIG. 3 that may be the server device 106 discussed above with reference to FIGS. 1A and 1B. As such, the server device 300 may include a server or a plurality of servers or computers that distribute operations across the plurality of servers. In the illustrated embodiment, the server device 300 includes a chassis 302 that houses the components of the server device 300, only some of which are illustrated in FIG. 3. For example, the chassis 302 may house a processing system (not illustrated) and a non-transitory memory system (not illustrated) that includes instructions that, when executed by the processing system, cause the processing system to provide augmented reality hierarchical device localization controller 304 that is configured to perform the functions of the augmented reality hierarchical device localization controller or servers discussed below. In the specific example illustrated in FIG. 3, the augmented reality hierarchical device localization controller 304 may be configured to perform at least a portion of the augmented reality functionality described herein such that resources on the augmented reality device 102 may be freed to perform other functionality.

The chassis 302 may further house a communication system 306 that is coupled to the augmented reality hierarchical device localization controller 304 (e.g., via a coupling between the communication system 306 and the processing system) and that is configured to provide for communication through the network 104 as detailed below. The communication system 306 may allow the server device 300 to send and receive information over the network 104 of FIG. 1A and FIG. 1B. The chassis 302 may also house a storage device (not illustrated) that provides a storage system 308 that is coupled to the augmented reality hierarchical device localization controller 304 through the processing system. The storage system 308 may be included in the augmented reality database 112 of FIG. 1A and FIG. 1B. The storage system 308 may be configured to store augmented reality profiles 310 in one or more augmented reality repositories (e.g., such as the augmented reality profiles 112a). Each augmented reality profile 310 may include an augmented reality model 312, one or more LOIs 313, feature points 314 of anchors or LOIs, one or more virtual-to-physical environment mappings 315, or localization content 316. For example, and as discussed above, the LOIs 313 may include a coordinate such as longitude, latitude, altitude, or any other location information. The feature points 314 may include computer recognizable points in the physical environment 103 (e.g., an anchor) that are associated with the LOI 313 or the augmented reality model 312. The feature points 314 may be included in the virtual-to-physical environment mapping 315 that maps the augmented reality model 312 to the physical environment 103 and used to localize the augmented reality device 102/200 to the augmented reality model 312. The augmented reality model 312 may include a two-dimensional image/model, a three-dimensional image/model, annotation content, text, an audio file, a video file, a link to a website, an interactive annotation, or any other visual or auditory annotations that may be superimposed on or near a LOI(s) 313 that the augmented reality model 312 is associated with in the physical environment 103 being reproduced on a display screen included on a display system 224 of the augmented reality device 200. The augmented reality model 312 may also include rendering instructions that provide instructions to the augmented reality device 200 as to how the augmented reality device 200 is to display the augmented reality model 312 via the display system 224. In various embodiments, the localization content 316 may include visual content for directing a user to an anchor or localization location. For example, the localization content 316 may include video content and location information associated with the video content that directs a user from a macro-area of a physical environment to a micro-area of a physical environment that includes the LOI 313 or feature points 314 of an anchor. In other embodiments, the localization content 316 may include sets of images where each set is associated with a location and each image of the set is associated with an orientation. In addition, the storage system 308 may include at least one application that provides instruction to the augmented reality hierarchical device localization controller 204 when providing augmented reality models 312 on a display system 224.

While the augmented reality profile(s) 310 on the server device 300 is shown separate from the augmented reality profile(s) 218 on the augmented reality device 200, the augmented reality profile(s) 310 and 218 may be the same, a portion of the augmented reality profile(s) 310 and 218 on each storage system 216 and 308 may be the same (e.g., a portion of the augmented reality profile(s) 310 are cached on the augmented reality device 200 storage system 216), or the augmented reality profile(s) 310 and 218 may be different. In some embodiments, if the augmented reality profile(s) 310 and 218 are the same, the information of a particular augmented reality profile may be distributed between the server device 300 and the augmented reality device 200 such that a portion of any of the information included in the augmented reality profile (the augmented reality model 219/312, one or more LOIs 220/313, feature points 221/314, one or more physical environment mappings 222/315, or localization content 223/316) is stored on the storage system 308 while another portion is stored on the storage system 216. While a specific server device 300 has been illustrated, one of skill in the art in possession of the present disclosure will recognize that server devices (or other devices operating according to the teachings of the present disclosure in a manner similar to that described below for the server device 300) may include a variety of components and/or component configurations for providing conventional computing device functionality, as well as the functionality discussed below, while remaining within the scope of the present disclosure as well.

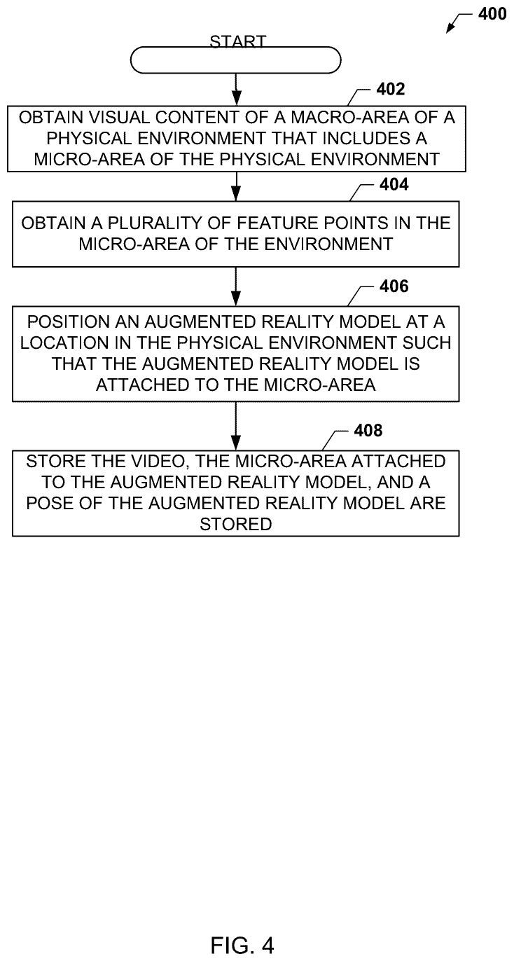

FIG. 4 depicts an embodiment of a method 400 of establishing a hierarchical device localization for augmented reality, which in some embodiments may be implemented with the components of FIGS. 1, 2, and 3 discussed above. As discussed below, some embodiments make technological improvements to content management, augmented reality, and other technology areas. The method 400 is described as being performed by the augmented reality hierarchical device localization controller 204 on the augmented reality device 102/200. Furthermore, it is contemplated that the augmented reality hierarchical device localization controller 304 on the server device 106/300 may include some or all the functionality of the augmented reality hierarchical device localization controller 204. As such, some or all of the steps of the method 400 may be performed by the server device 106/300 and still fall under the scope of the present disclosure. As mentioned above, the server device 106/300 may include one or more processors or one or more servers, and thus the method 400 may be distributed across the those one or more processors or the one or more servers.

The method 400 may begin at block 402 where visual content of a macro-area of a physical environment that includes a micro-area of the physical environment may be obtained. As discussed above, developer application kits (e.g., ARCore or ARKit) that may be included in the augmented reality hierarchical device localization controller 204/304 are used to build augmented reality experience for various operating systems and augmented reality devices. The developer application kit tracks the position of the augmented reality device 102 as it moves and builds its own understanding of the real world. The developer application kits use motion tracking technology via the imaging sensors 232 (e.g., camera) to identify interesting points, called feature point, and tracks how those points move over time. With a combination of the movement of these feature points and readings from the positioning sensors 230 (e.g., inertial sensors, compass, GPS, beacon sensors, or the like), the developer application kit determines both the location and orientation of the augmented reality device 102/200 as it moves through the physical environment 103. As the augmented reality device 102/200 moves through the physical environment 103, the developer application kit may use a process called simultaneous localization and mapping (SLAM) to understand where the augmented reality device 102/200 is relative to the physical environment 103. The captured feature points are used in the SLAM process to compute a change in location of the augmented reality device 102/200. The visual information as well as the inertial measurements are used to estimate a pose (location and orientation) of the imaging sensor 232 relative to the physical environment 103. The developer application kit aligns a pose of a virtual imaging sensor that renders the augmented reality model(s) with the pose of the imaging sensor 232 included on the augmented reality device 102/200 to render the augmented reality model from the correct perspective and overlay the augmented reality model on top of the image obtained from the imaging sensor 232. As such, the augmented reality models appear from the correct perspective and the augmented reality models appear as if the augmented reality model is part of the physical environment 103.

However, poses can change as the developer application kit improves its understanding of the physical environment 103. When placing an augmented reality model in the physical environment 103, an anchor is often defined to ensure that the developer application kit tracks the augmented reality model over time. Otherwise, without the anchor and over time, an augmented reality model may appear to drift away from where it was placed. As such, an augmented reality model is attached to an anchor in the physical environment 103 (e.g., by capturing feature points of the anchor and mapping the feature points of the augmented reality model to the feature points of the anchor). When the same augmented reality device 102/200 that placed the augmented reality object or a different augmented reality device 102/200 comes into the physical environment 103 and is instructed to view the augmented reality models, that device needs to capture the feature points of the anchor to align the pose of the imaging sensor 232 of the augmented reality device 102/103 to the pose of the virtual imaging sensor that renders the augmented reality model. However, the anchor is typically difficult to find as it is often of a “micro-view” of the physical environment 103. For example, the anchor may be of some relatively small physical object in the physical environment 103 to achieve the best mapping between the anchor's feature points and the augmented reality model. As such, in a physical environment that is relatively large, finding the anchor, even if an image or a description of the anchor is provided to a user, is cumbersome and time consuming.

Further still, while relatively large, open physical environments provide some difficulty for a user to locate an anchor, indoor spaces and spaces with many objects that could potentially be anchors results in issues with current localization technologies where static images and global positioning are used alone to direct a user to an anchor. For example, a GPS reading by a user device may result in an image to be produced on the user device of an anchor. However, that anchor may be in another room or in a room where there are many objects, and it is difficult for the user to locate the anchor as GPS alone may not provide the necessary granularity.

Thus, in various embodiments at block 402, a video that includes a series of images of a macro-area of a physical environment to a micro-area of the physical environment may be recorded. For example, the augmented reality device 102/200 via the imaging sensor 232 may record a video of a macro-area of the physical environment 103 to a micro-area of the physical environment 103 where the anchor is located. For example, the video may begin with an image at a “zoomed out” view of the physical environment 103 or an image of a recognizable area (e.g., signage at the front of a building). The video may then proceed to include a series of images of the physical environment 103 that show how to navigate to the augmented reality anchor 109a or 109b and end with images of a micro-area where the augmented reality anchor 109a is located. For example, the video may zoom-in from a wide environment view to a narrow environment view. In other examples, the video may capture images from the macro-area beginning image and images captured as the augmented reality device 102/200 moves through the physical environment 103 until the augmented reality device 102/200 arrives at the micro-area where the augmented reality anchor 109a is located.

When the augmented reality device 102/200 initiates the recording of the video, the augmented reality hierarchical device localization controller 204 may also capture a geolocation (e.g., coordinates provided by a GPS or an indoor navigation system) via the positioning sensors 230. The geolocation may be used to direct a user of an augmented reality device 102/200 to the macro-area, obtain videos for a physical environment 103 at which the augmented reality device 102/200 is located, or order provided videos displayed on the display of the display system 224 based on a current location of the augmented reality device 102/200 and the geolocations associated with each video. In some embodiments, block 402 may be performed before defining the anchor and positioning the augmented reality model in blocks 404 and 406, discussed below, or after defining the anchor and positioning the augmented reality model in blocks 404 and 406.

In other embodiments, instead of obtaining a video of a macro-area to a micro-area at block 402, augmented reality device 200 may capture an image of the macro-area and the micro-area and capture position information of the imaging sensor 232 when the image was captured by the imaging sensor 232. In various embodiments, the micro-area may include the augmented reality anchor 109a where feature points are captured as discussed in more detail below. The augmented reality hierarchical device localization controller 204 may also capture the position information such as a location of the augmented reality device 200 or the imaging sensor 232 using the positioning sensors 230 (beacon sensors or GPS). The augmented reality hierarchical device localization controller 204 may capture the orientation of the augmented reality device 200 or the imaging sensor 232 via an IMU or a compass included in the positioning sensors 230. The position information may be associated with the image and stored as localization content 223/316.

Furthermore, a second image may be captured that includes another view of the macro-area that includes a separate micro-area. For example, the micro-area may include the augmented reality anchor 109b where feature points are captured, as discussed in more detail below. The augmented reality hierarchical device localization controller 204 may also capture the position information such as a location of the augmented reality device 200 or the imaging sensor 232 using the positioning sensors 230 (beacon sensors or GPS). The augmented reality hierarchical device localization controller 204 may capture the orientation of the augmented reality device 200 or the imaging sensor 232 via an IMU or a compass included in the positioning sensors 230. The position information may be associated with the image of that includes the augmented reality anchor 109b and stored as localization content 223/316. While described, as the augmented reality device 200 capturing and obtaining the visual content and position information, the server device 300 may obtain the captured visual content and position information from the augmented reality device 200.

The method 400 may proceed to block 404 where a set of feature points in the micro-area of the environment are obtained. In an embodiment, at block 404, the augmented reality device 102/200 via the imaging sensor 232 may obtain a set of feature points in the physical environment 103. The augmented reality hierarchical device localization controller 204 may capture feature points of the physical environment 103 that includes an augmented reality anchor 109a/109b that is or will be attached to an augmented reality model. As discussed above, by capturing feature points of the micro-area of the physical environment 103, later augmented reality experiences with the augmented reality model may use the feature points to localize the imaging sensor 232 of the augmented reality device 102/200 by aligning a pose of the imaging sensor 232 of the augmented reality device 102/200 with a pose of a virtual imaging sensor of the view of the augmented reality model so that the augmented reality model is aligned in the images generated by the imaging sensor 232 of the augmented reality device 102/200 as intended.

The method 400 may proceed to block 406 where an augmented reality model is positioned and orientated in the physical environment in the mapped micro-area. In an embodiment, at block 406, the user via the user input/output system 226 and the display system 224 may select, position, and orientate an augmented reality model 219 in an image frame provided by the imaging sensors 232 on the display system 224. For example, the user may select a point on an image frame displayed on a touchscreen display by touching the touchscreen. The developer application kit may identify planes (e.g., a tabletop, a countertop, a shelf, a floor, a wall, or other planes) in the image frame via captured feature points. When the user selects a location to place the augmented reality model in the physical environment 103, the augmented reality hierarchical device localization controller 204 may associate the augmented reality model 219 with a plane associated with that selected location.

In various embodiments, the augmented reality hierarchical device localization controller 204 may include a positioning feature that utilizes the touchscreen and the positioning sensor 230 to orientate the augmented reality model 219 in the physical environment 103 displayed on the display of the augmented reality device 200. For example, when a user slides a finger to the right, the augmented reality model 219 may move to the right on the plane. If the user slides a finger up, the augmented reality model 219 may move on the plane away from the user. In another example, to raise the augmented reality model 219 off the plane, the user may raise the augmented reality device 102/200 as detected by the IMU included in the positioning sensors 230. If the user rotates the augmented reality device 102/200, the augmented reality hierarchical device localization controller 204 may rotate the augmented reality model 219 according to the rotation.

In various embodiments, the augmented reality model 219 may include a virtual map or a virtual model of the physical environment 103 that may be a previously generated map or a map created by the augmented reality hierarchical device localization controller 204 during block 406. For example, the augmented reality hierarchical device localization controller 204 may include a virtual model algorithm or may be in communication with virtual model application program interface (API) such as, for example, RoomPlan API by Apple® of Cupertino, California, USA. The virtual model algorithm with the imaging sensor 232 of the augmented reality device 200 may create a virtual model of a space in the physical environment 103 as the augmented reality device 200 scans the space in the physical environment 103. The augmented reality hierarchical device localization controller 204 may obtain one or more virtual models of the physical environment 103 and position and orientate those virtual models to the virtual camera pose which is mapped to the physical camera pose via the anchors. The virtual models may be segmented and a user may position and align them to form a complete virtual model of the physical environment 103.

The method 400 may proceed to block 408 where the visual content, the micro-area/anchor mapped to the augmented reality model (e.g., via feature points), and a pose of the augmented reality model are stored in a database in association with the augmented reality model. In an embodiment, at block 408, the visual content (e.g., video or image sets), the micro-area that includes the anchor attached to the augmented reality model 219, and the pose of the augmented reality model 219 may be stored in the augmented reality database 112. For example, the pose may be stored in the LOIs 220 and 313 such that position and orientation of the augmented reality model 219/312 is stored for future augmented reality experiences. The feature points of the anchor and the augmented reality model 219/312 may be stored as the feature points 221/313. The mappings between the micro-area/anchor and the augmented reality model 219/312 may be stored as mappings 222/315. The visual content such as the video that plays a series of images from the macro-area to the micro-area or images associated with position information (e.g., location and orientation when captured) may be stored as localization content 223/316. As discussed above, this data may be stored at the augmented reality device 200, the server device 300, both the augmented reality device 200 and the server device 300, or a first portion of the data may be stored on the augmented reality device 102/200 and a second portion of the data may be stored on the server device 106/300.

Thus, visual content used for displaying a guide from a macro-area to a micro-area may be associated with an anchor included in the micro-area may be obtained and generated such that a user may easily locate the anchor at another time and localize an augmented reality device. The user may define the anchor and associate it with the video. The anchor may be attached to one or more augmented reality models or a series of augmented reality models that spawn from an initial augmented reality model as a user interacts with the augmented reality experience.

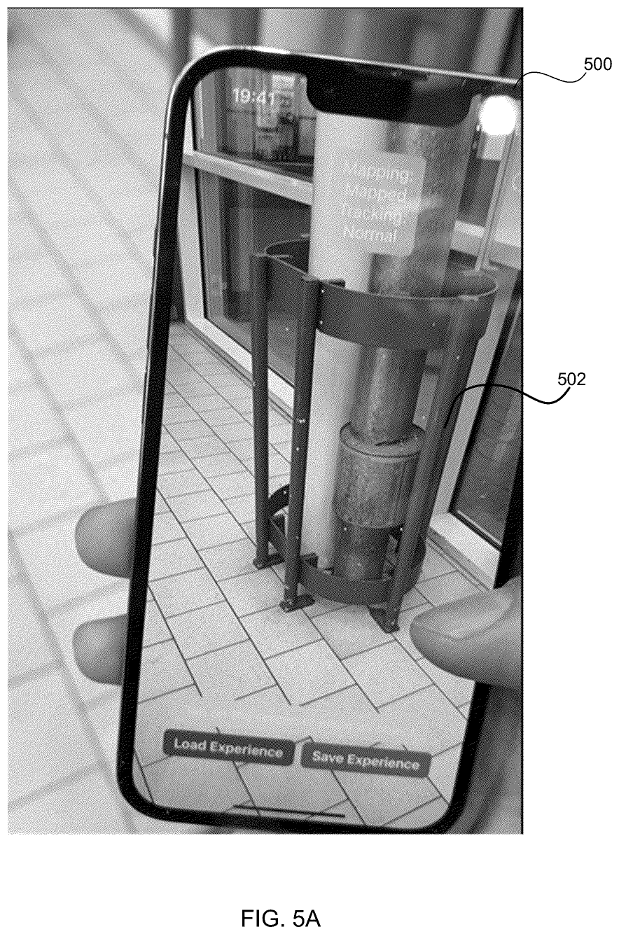

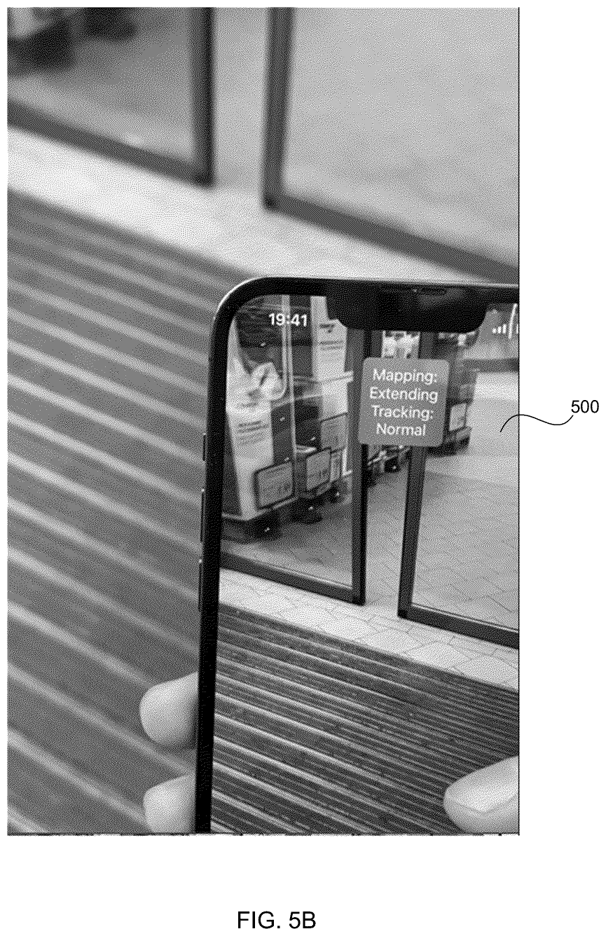

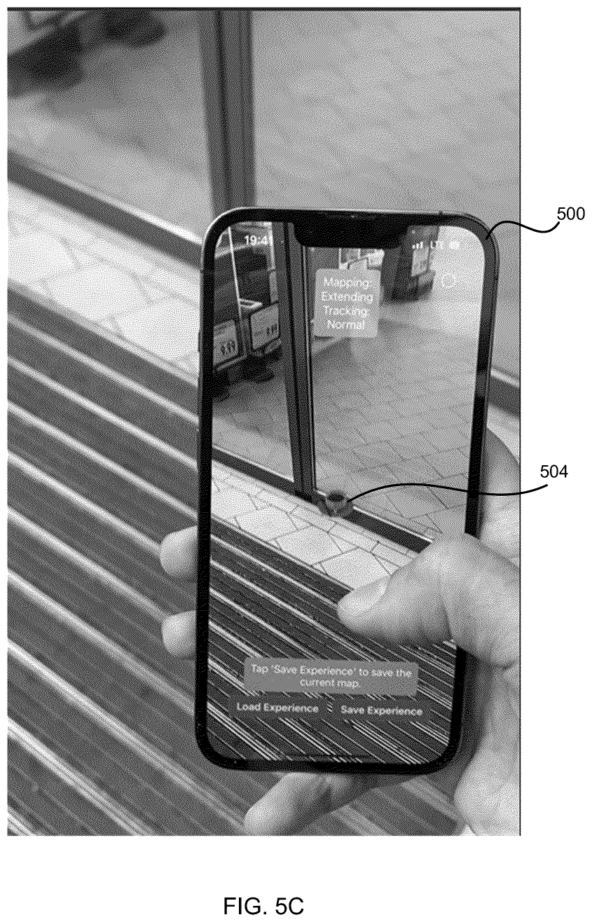

FIGS. 5A-5C illustrate various screenshots of an example implementation of the method 400 of FIG. 4 of mapping a video of a macro-area to a micro-area where feature points of the micro-area are attached to feature points of an augmented reality model. As illustrated in FIG. 5A, the user may record a video to a micro-area where features points of an anchor 502 may be obtained. The features points may be used to map a virtual imaging sensor pose to a physical imaging sensor pose. In FIG. 5B, the user may navigate the augmented reality device 500 to a new location and orientation. In FIG. 5C, the user may place an augmented reality model 504 (e.g., the coffee cup) in the virtual environment which is mapped via the pose mappings to the anchor and feature points.

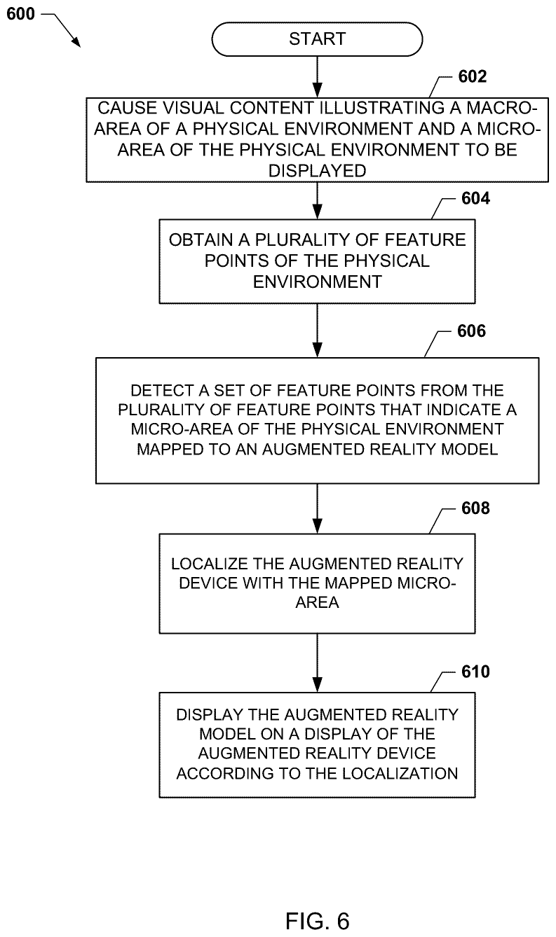

FIG. 6 depicts an embodiment of a method 600 of hierarchical device localization for augmented reality, which in some embodiments may be implemented with the components of FIGS. 1, 2, and 3 discussed above. As discussed below, some embodiments make technological improvements to content management, augmented reality, and other technology areas. The method 600 is described as being performed by the augmented reality hierarchical device localization controller 204 on the augmented reality device 102/200. Furthermore, it is contemplated that the augmented reality hierarchical device localization controller 304 on the server device 106/300 may include some or all the functionality of the augmented reality hierarchical device localization controller 204. As such, some or all of the steps of the method 600 may be performed by the server device 106/300 and still fall under the scope of the present disclosure. As mentioned above, the server device 106/300 may include one or more processors or one or more servers, and thus the method 600 may be distributed across the those one or more processors or the one or more servers.

The method 600 may begin at block 602 where a visual content illustrating a macro-area of a physical environment and a micro-area of the physical environment may be caused to be displayed on a display of an augmented reality device. In an embodiment, at block 602, the augmented reality device 102/200 via the display system 224 may display visual content. For example, a video that includes a series of image frames of a macro-area of the physical environment 103 to a micro-area of the physical environment 103 where the anchor is located may be displayed. The video may begin with an image at a “zoomed out” view of the physical environment 103 or an image of a recognizable area (e.g., signage at the front of a building). The video may then proceed to include image frames of the physical environment 103 and end with image frames displaying a micro-area where an anchor is located. For example, the video may zoom-in from a wide environment view to a narrow environment view. In other examples, the video may display images from the macro-area beginning image and continue to display images as the augmented reality device 102/200 moves through the physical environment 103 until the augmented reality device 102/200 arrives at the micro-area where the anchor is located.

In various embodiments, the augmented reality device 102/200 may obtain and display an image that includes a macro-area and a micro-area. The image may be associated with position information that may include a location associated with the image and an orientation associated with the image. The image may be included in a set of images that are provided to the augmented reality device 200 based on a location of the augmented reality device 200. Each of the images in an image set may also be associated with an orientation of an imaging sensor/camera at which the image was captured. The augmented reality hierarchical device localization controller 204 may determine which image set to load and which image to display based on the position information captured.

In some embodiments, the augmented reality device 200 may include the visual content as localization content 223. The server device 106/300 may have provided the localization content 316 via the network 104 in response to detecting a condition being satisfied such as a user request from the augmented reality device 102/200 or a geolocation from the positioning sensors 230 of the augmented reality device 102/200 being provided via the network 104 corresponding with a captured geolocation associated with the localization content 223/316 (e.g., within a predetermined distance (e.g., 6 meter, 10 meters, 20 meters, 30 meters, 60 meter, 100 meters or any other distances that would be apparent to one of skill in the art in possession of the present disclosure) of the stored geolocation associated with the localization content). The localization content 223/316 may include a plurality of videos where each video shows a macro-area of the environment to micro-area. Each video of the plurality of videos may include a different macro-area and a different micro-area that is attached to the same augmented reality model 219.

In various embodiments, different augmented reality models 219 may be attached to one or more anchors that are different from other augmented reality models 219. For example, a department store that has an augmented reality map that is overlayed with the objects in the store may have an anchor attached to that augmented reality map at different entrances of the store or at anchors within the store. However, some anchors in the store may be attached to other augmented reality models. Some anchors may include a plurality of augmented reality models attached to the anchor and the user may be presented with an option to select an augmented reality model or a particular augmented reality model may be presented based on a presentation condition being satisfied (e.g., time of day, a particular user associated with the augmented reality device, a temperature, or other condition that would be apparent to on of skill in the art in possession of the present disclosure).

When the augmented reality device 102/200 receives multiple videos for the augmented reality model. Links to those videos may be displayed on the display of the display system 224. The user may select the preferred video to play. In some embodiments, the order at which the videos are to be displayed are based on the distance between the geolocation of the augmented reality device 102/200 and the geolocation associated with the video. The videos may be displayed from shortest distance to longest distance.

In other embodiments, the localization content 223/316 may include one or more sets of images. A set of images may be defined by a location at which those images are associated with. For example, the images in a set may be associated with a common location or within common location threshold (e.g., within 1 ft., 2 ft., 5 ft., 10 ft., 20 ft., 50 ft., 100 ft. or any other distance from a location associated with the images). The augmented reality hierarchical device localization controller 204 may determine a location of the augmented reality device 200 using the positioning sensors 230 and determine which of the sets of images satisfy a proximity condition based on location information associated with the sets of images. The set of images that is closest to the location of the augmented reality device 200 may be available for display. The augmented reality hierarchical device localization controller 204 may then determine which of the images in the set of images has an orientation associated with it that satisfies an orientation threshold with a current orientation of the augmented reality device 200. For example, the image in the set of images that is associated with an orientation that is closest to the orientation of the augmented reality device 200 may be displayed.

In some embodiments, a portion of one image may displayed while a portion of another image of the set may be displayed. For example, the user may be moving the augmented reality device 200 around in the physical environment 103 such that the orientation of the augmented reality device 200 changes while the first image is displayed. As the orientation of the augmented reality device 200 moves further away from the orientation associated with the first image and closer to an orientation associated with a second image, the view of the first image may move out of the display while the view of the second image moves into the viewable region of the display. However, in other embodiments, the first image may fade as it becomes further away from the orientation of the augmented reality device 200 and the second image may gradually appear as the orientation of the second image becomes closer to the orientation of the augmented reality device 200.

Furthermore, as the augmented reality device 200 changes position, the second set of objects may populate the display. For example, the user may be moving the augmented reality device 200 around in the physical environment 103 such that the location of the augmented reality device 200 changes while the first image is displayed and first set of images are being provided. As the location of the augmented reality device 200 moves further away from the location associated with the first set of images and closer to a location associated with a second set of images, the view of the first image of the first set of images may move out of the viewable region display while the view of an image of a second set of images moves into the viewable region of the display. Which of the second set of images to be displayed may be based on the current orientation of the augmented reality device 200.

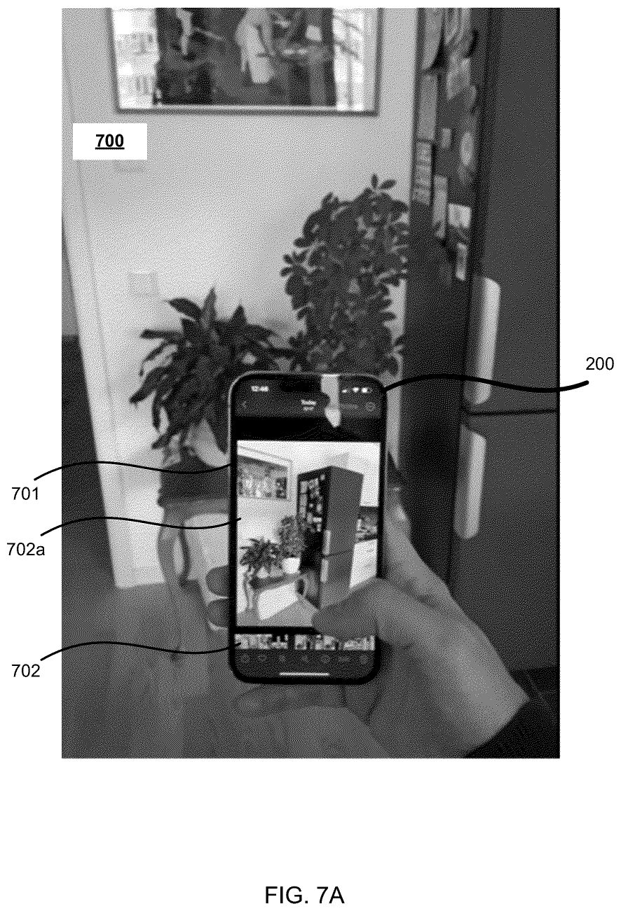

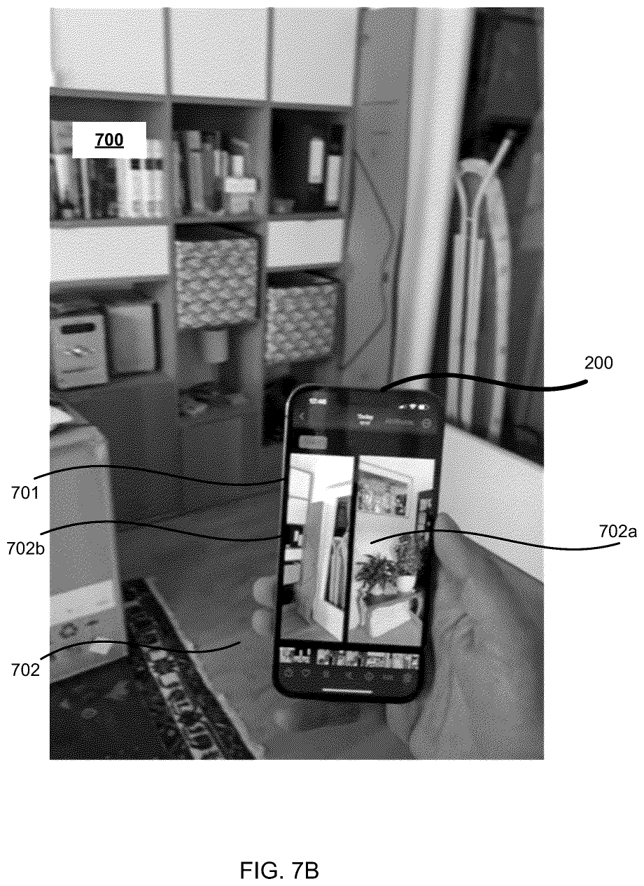

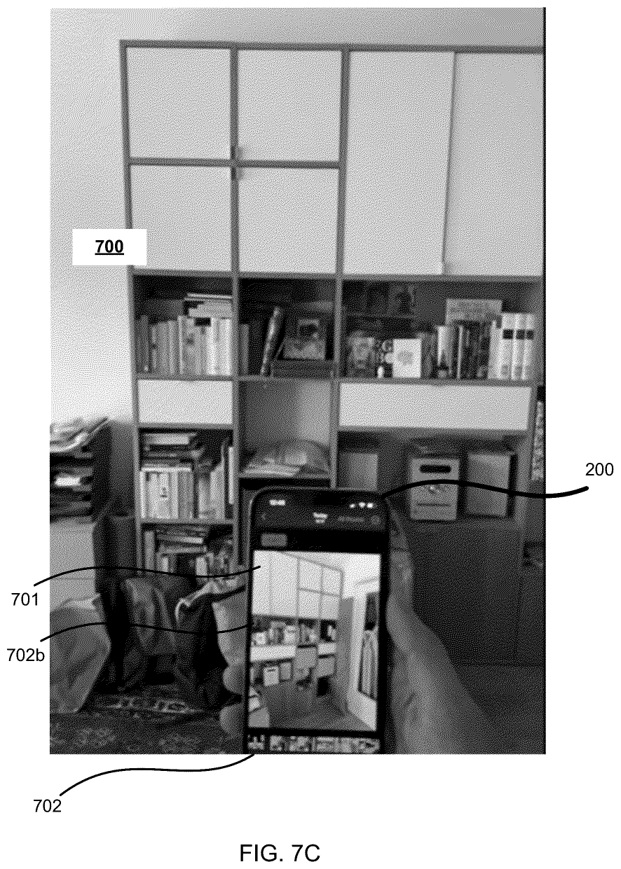

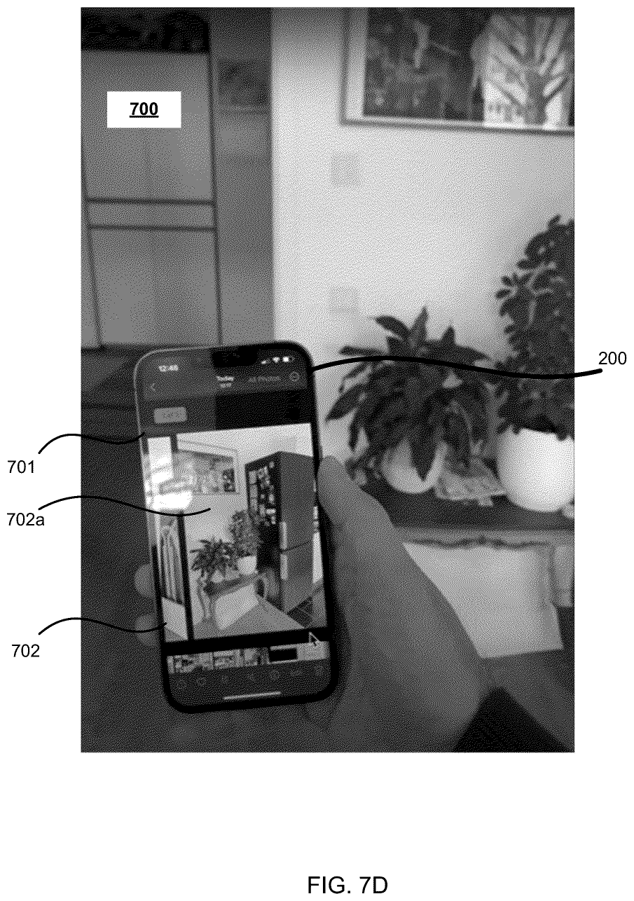

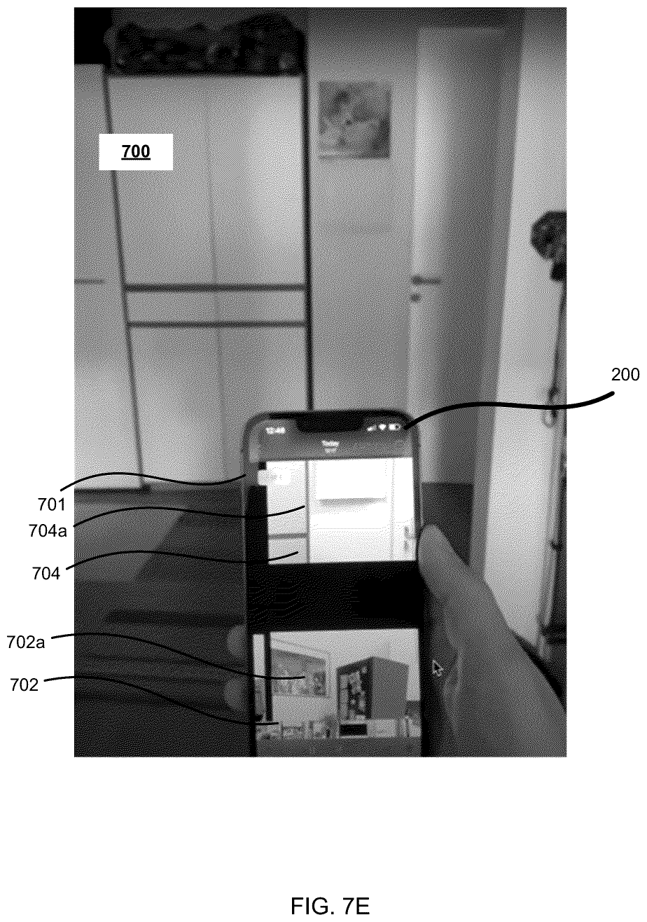

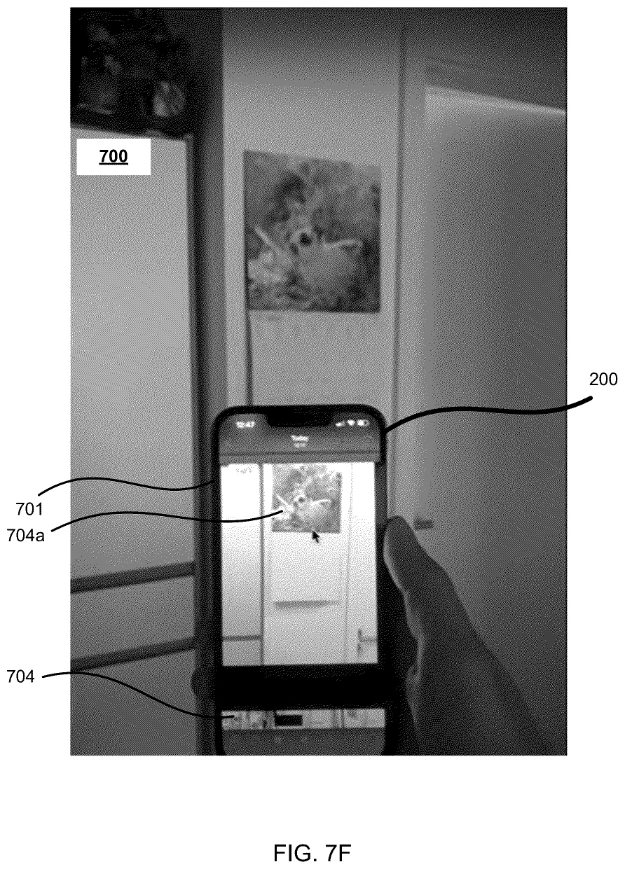

FIGS. 7A-7F illustrate screenshots of image sets and images being provided for display based on orientation and location. FIG. 7A illustrates the augmented reality device 200 at a first location and a first orientation in environment 700. A first set of images 702 are loaded and viewable on a display 701 with a first image 702a of the first set of images 702 being predominantly viewed on the display 701 because the orientation of the augmented reality device 200 is closest to the orientation associated with the first image 702a. FIG. 7B illustrates the user moving away from the first orientation in FIG. 7A to a second orientation. The second orientation may be the same number of degrees from the orientation associated with the first image 702a as it is from the orientation associated with a second image 702b of the first set of images 702. As such, a portion of the first image 702a and a portion of the second image 702b is displayed. FIG. 7C illustrates the augmented reality device 200 at a third orientation that corresponds to the orientation of the second image 702b. As such, the second image 702b is displayed.

FIG. 7D illustrates the augmented reality device 200 back at the first location and the first orientation in environment 700. The first set of images 702 are loaded and viewable on a display 701 with the first image 702a of the first set of images 702 being predominantly viewed on the display 701 as in FIG. 7A. FIG. 7E illustrates the user moving forward and thus changing a location of the augmented reality device 200 from the first location to a second location. The second location may be equidistance or substantially equidistance from the first location and a third location associated with a second set of images. As such, a portion of the first image 702a and a portion of a first image 704a of a second set of images 704 is displayed. FIG. 7F illustrates the augmented reality device 200 at a third location that corresponds to the location of the second set of images 704. As such, the first image 704a of the second set of images is displayed. The first image 704a of the second set of images 704 may satisfy the orientation condition for that image to be displayed. In various embodiments, each image of the first set of images 702 and the second set of images 704 may include an anchor to which the user may position their phone to localize the augmented reality device 200 with an augmented reality object.

The method 600 may proceed to block 604 where a plurality of feature points are obtained of the physical environment while the visual content is presented. In an embodiment, at block 604, the augmented reality hierarchical device localization controller 204/304 may be obtaining feature points from the imaging sensor 232 as the display system 224 is displaying an image of the physical environment 103 on a display. In some embodiments, the visual content may be presented while the image of the physical environment 103 is being displayed. The visual content may continue to loop (e.g., in the video embodiment) while feature points from the continuously updated image captured from the imaging sensors 232 are displayed when the augmented reality device 102/200 is moving through the physical environment.

The method 600 may proceed to block 606 where a set of feature points from the plurality of feature points that indicates a micro-area of the physical environment mapped to an augmented reality model are detected. In an embodiment, at block 606, the augmented reality hierarchical device localization controller 204/304 may compare the feature points from the captured images to feature points 221/314 associated with anchors of the augmented reality models 219/312. When there is a threshold of similarity between a set of captured feature points and feature points associated with an anchor that is in turn associated with an augmented reality model 219/312 via the one or more virtual-to-physical environment mappings 222/315, a match may be determined. In some embodiments, the feature points 314 of a particular augmented reality model associated with the selected visual content may be provided from the server device 106/300 via the network 104 to the augmented reality device 102/200 when the visual content is selected such that the feature points 314 may be cached as feature points 221 for faster processing. In some embodiments, the entire augmented reality profile 310 may be provided and cached at the augmented reality device 102/200 as augmented reality profile 218 when localization content 316 associated with the augmented reality profile 310 is selected. This enables storage savings at the augmented reality device 102/200 as well as faster processing, as the augmented reality device 102/200 may receive the augmented reality profile 310 as the user is attempting to locate the micro-area. Other caching schemes for storing and processing augmented reality profiles 218 and 310 at the augmented reality device 102/200 may be contemplated to reduce network u sage, conserve storage and memory resources at the augmented reality device 102/200 or provide faster processing.

The method 600 may proceed to block 608 where the augmented reality device is localized with the mapped micro-area. In an embodiment, at block 608, the augmented reality hierarchical device localization controller 204/304 may localize the imaging sensor 232 in relation to the augmented reality model 219 using the augmented reality anchor. For example, the augmented reality hierarchical device localization controller 204/304 may align the pose of a virtual camera view of the augmented reality model 219 associated with the augmented reality anchor 109a or 109b with the pose of the imaging sensor 232 as determined by the inertial tracking information provided by the positioning sensors 230.

The method 600 may proceed to block 610 where an augmented reality model is displayed based on the localization. In an embodiment, at block 610, the augmented reality hierarchical device localization controller 204/304 may cause the augmented reality model 219 to be displayed on the display of the display system 224 according to the localization of the augmented reality device 102/200. In some embodiments, a plurality of augmented reality models 219 may be associated with the augmented reality anchor 109a or 109b and the augmented reality hierarchical device localization controller 204/304 may provide, via the display provided by the display system 224, the augmented reality models as options for the user to select which augmented reality experience the user wants to experience. In further embodiments, if the augmented reality device 102/200 becomes misaligned during the augmented reality experience, then the augmented reality models, such as annotation content, may appear on the display of the augmented reality device 102/200 indicating to the user to re-localize the augmented reality device 102/200 at an anchor. Augmented reality arrows, one of the videos, an image from a set of images, or other localization content 223 may be displayed to direct the augmented reality device 102/200 to an anchor to re-localize for the current augmented reality experience.

In some embodiments, the augmented reality model 219 may be an augmented reality navigation experience that directs the user and the augmented reality device 102/200 through the physical environment 103 to various locations. For example, a to-do list augmented reality experience may direct the user to a first location for the user to complete a first task, then to a second location to for the user complete a second task, and so on until the tasks are completed. In various embodiments, during the augmented reality experience, the user may re-localize the augmented reality device 102/200 at another micro-area and anchor. The user that created the augmented reality experience may have performed another mapping of the augmented reality model with a second anchor such that future users could re-localize their augmented reality device 102/200 along the navigation path so that the future user of the augmented reality experience does not have to go back to the beginning anchor. These anchors, which may be directed by the macro-area to micro-area videos or image sets, may only be available during an augmented reality experience such that the visual content is only available during that augmented reality experience.

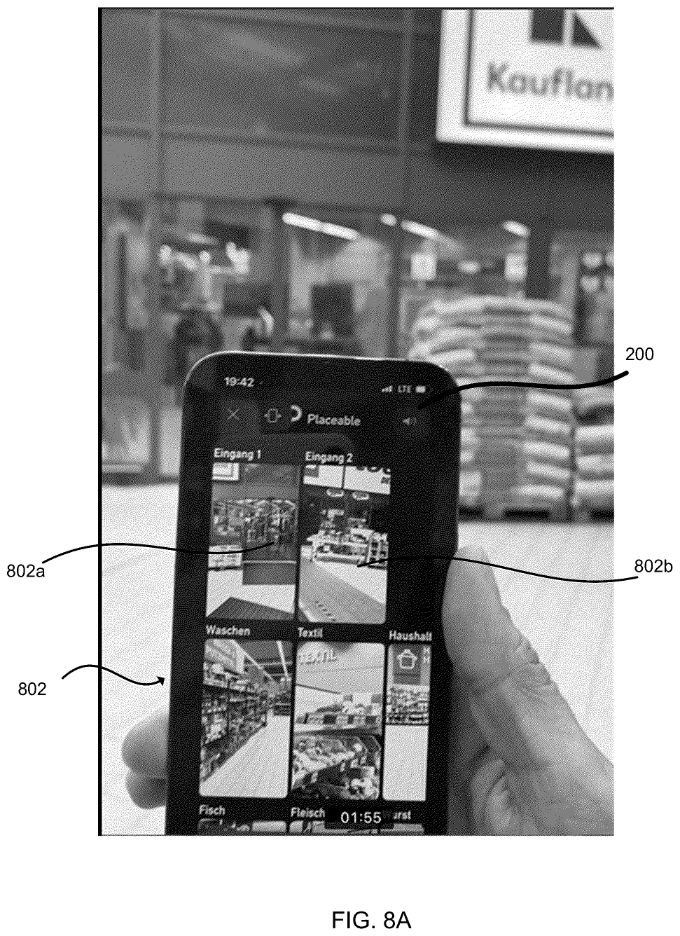

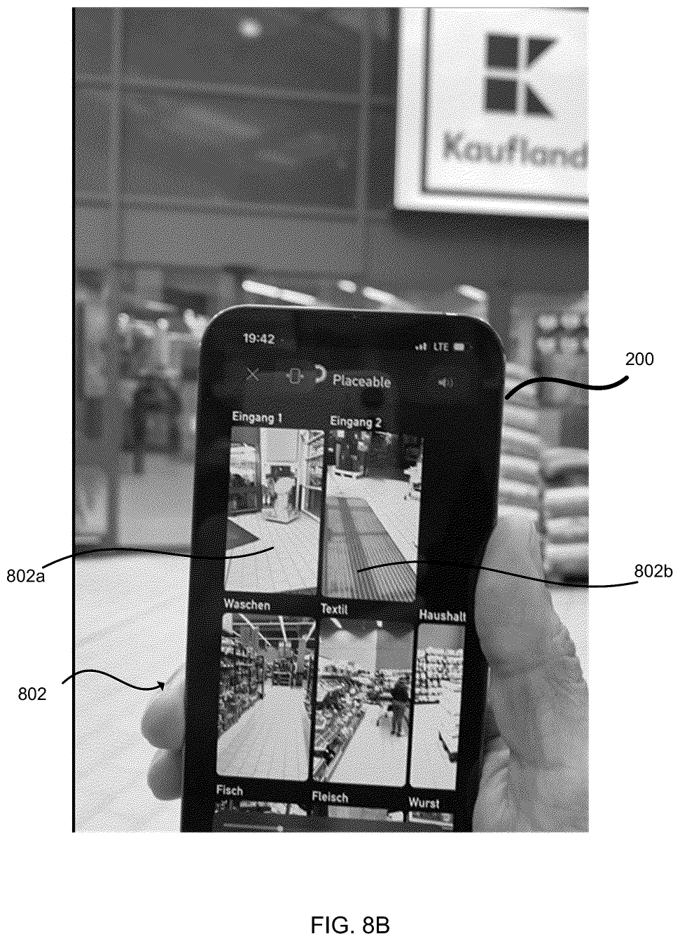

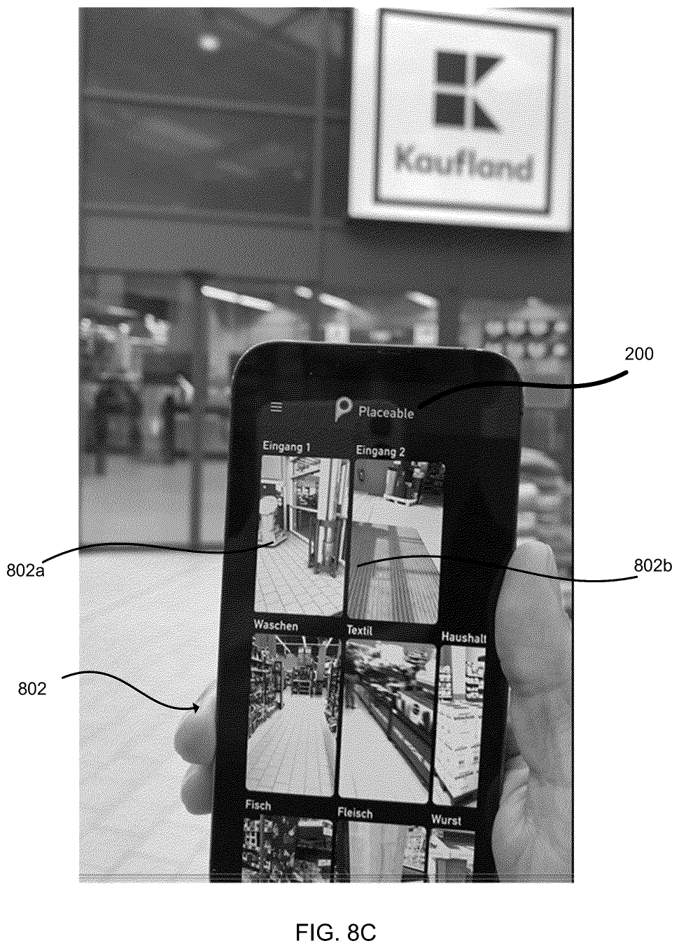

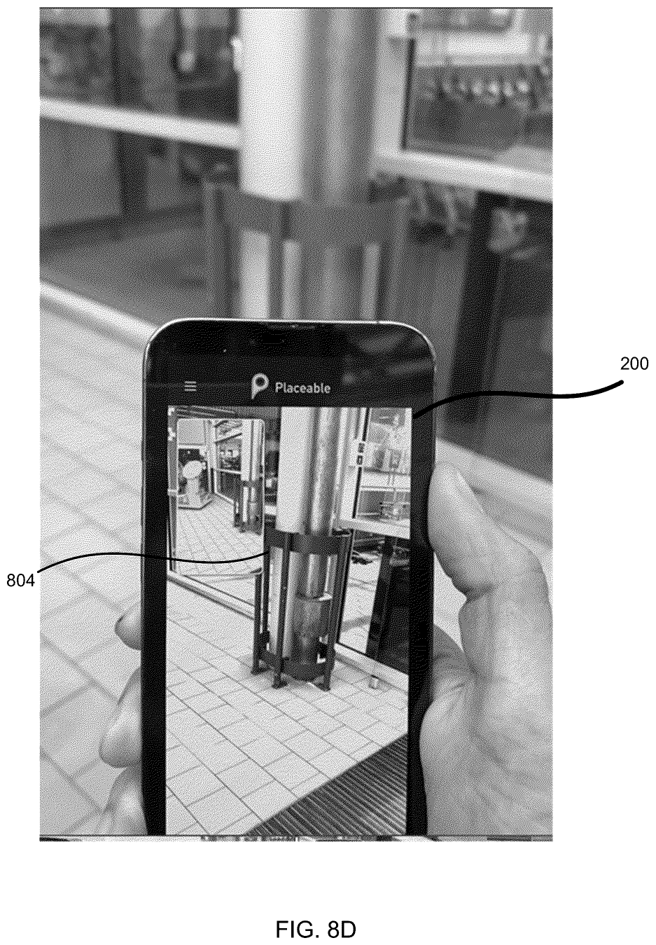

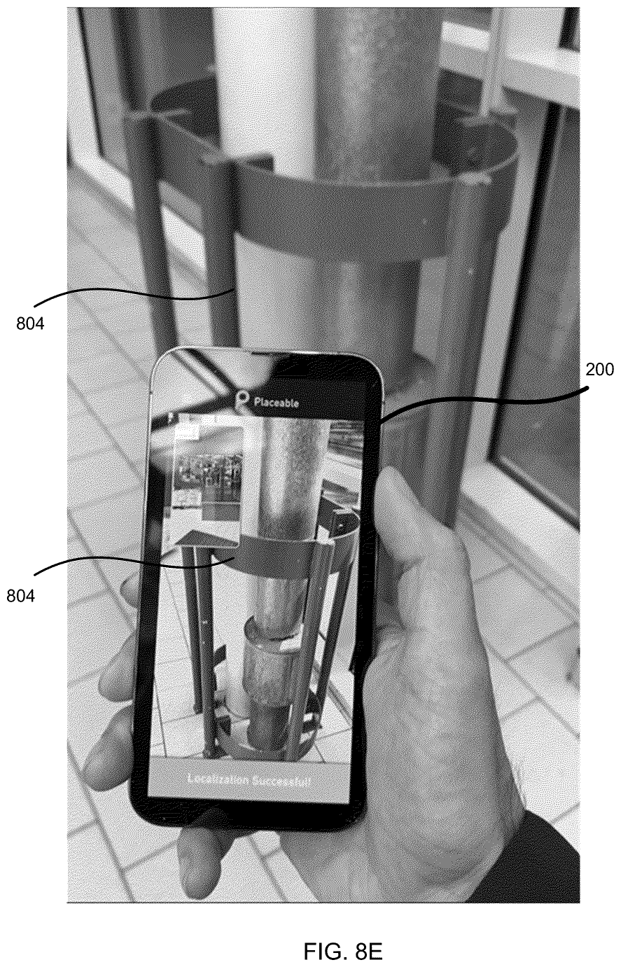

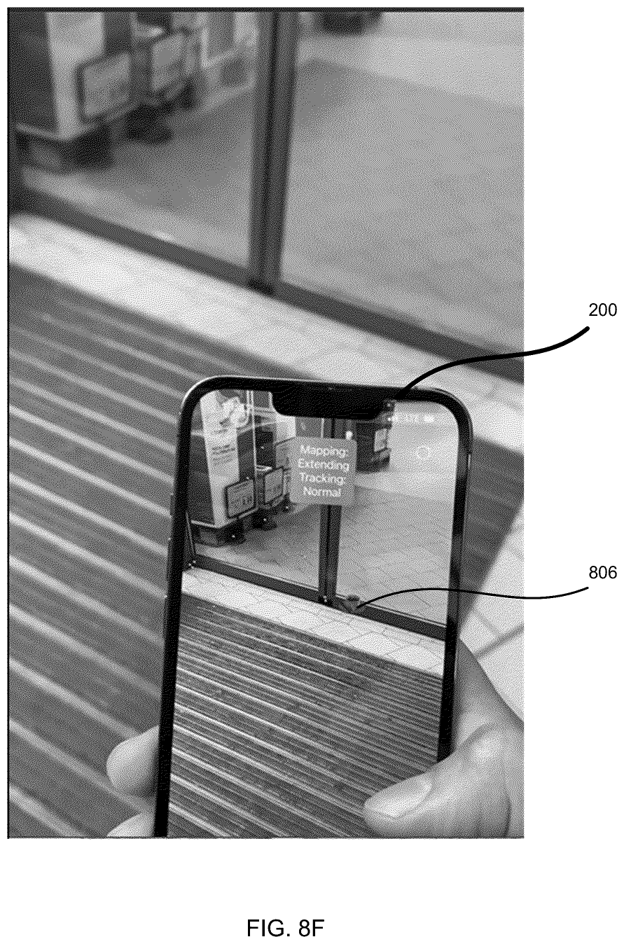

FIG. 8A-8F illustrate a series of screenshots of an example implementation of augmented reality hierarchical device localization according to the method 600 of FIG. 6. FIG. 8A illustrates visual content 802 being selected and displayed based on a location of the augmented reality device 200. In the illustrated embodiment, a plurality of videos that satisfy a proximity condition based on a location of the augmented reality device 200 are displayed. The video 802a that is associated with a location that is closest to the location of the augmented reality device 200 may be displayed first, the video 802b with the next closest location may be displayed second, and so on. FIG. 8B and FIG. 8C illustrate the videos 802a and 802b playing while the augmented reality device 200 is at the location. The videos may show a series of images that direct the user from the macro-area to a micro-area where the features points and anchor are located as in FIG. 8C. FIG. 8D illustrates that the user has moved the augmented reality device 200 to the anchor 804. FIG. 8E illustrates that the augmented reality device 200 has successfully localized with the anchor 804 and the pose of the virtual camera associated with the augmented reality model by detecting the feature points. FIG. 8F illustrates that when the augmented reality device 200, an augmented reality model 806 that is mapped to anchor 804 may be displayed on the display of the augmented reality device 200.

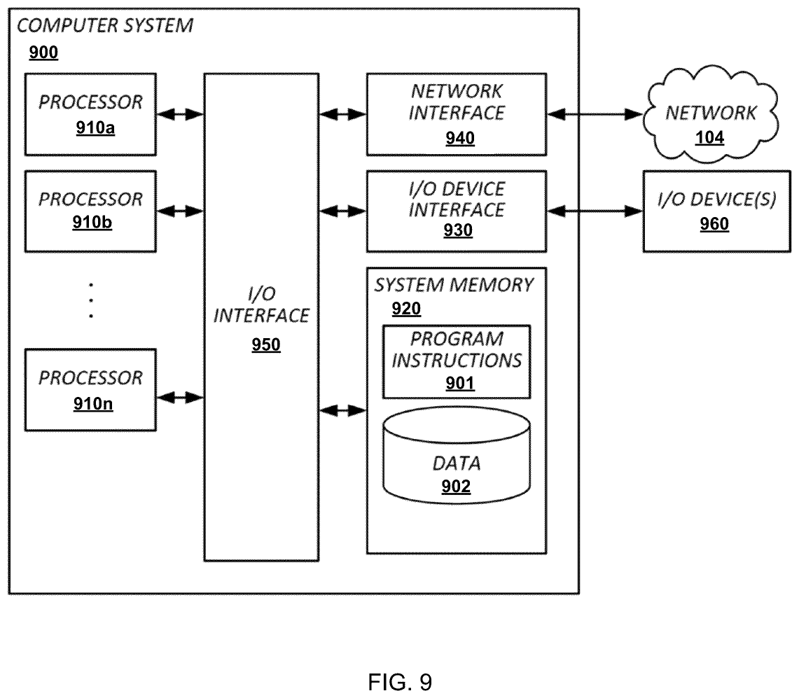

FIG. 9 is a diagram that illustrates an exemplary computing system 900 in accordance with embodiments of the present technique. The augmented reality devices 102 and 200 and the server devices 106 and 300, discussed above, may be provided by the computing system 900. Various portions of systems and methods described herein, may include or be executed on one or more computing systems similar to computing system 900. Further, processes and modules described herein may be executed by one or more processing systems similar to that of computing system 900.

Computing system 900 may include one or more processors (e.g., processors 910a-910n) coupled to system memory 920, an input/output I/O device interface 930, and a network interface 940 via an input/output (I/O) interface 950. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 900. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 920). Computing system 900 may be a uni-processor system including one processor (e.g., processor 910a), or a multi-processor system including any number of suitable processors (e.g., 910a-910n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 900 may include a plurality of computing devices (e.g., distributed computing systems) to implement various processing functions.

I/O device interface 930 may provide an interface for connection of one or more I/O devices 960 to computing system 900. I/O devices may include devices that receive input (e.g., from a user) or output information (e.g., to a user). I/O devices 960 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 960 may be connected to computing system 900 through a wired or wireless connection. I/O devices 960 may be connected to computing system 900 from a remote location. I/O devices 960 located on remote computing system, for example, may be connected to computing system 900 via a network and network interface 940.

Network interface 940 may include a network adapter that provides for connection of computing system 900 to a network. Network interface 940 may facilitate data exchange between computing system 900 and other devices connected to the network. Network interface 940 may support wired or wireless communication. The network may include an electronic communication network, such as the Internet, a local area network (LAN), a wide area network (WAN), a cellular communications network, or the like.

System memory 920 may be configured to store program instructions 901 or data 902. Program instructions 901 may be executable by a processor (e.g., one or more of processors 910a-910n) to implement one or more embodiments of the present techniques. Instructions 901 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 920 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM or DVD-ROM, hard-drives), or the like. System memory 920 may include a non-transitory computer readable storage medium that may have program instructions stored thereon that are executable by a computer processor (e.g., one or more of processors 910a-910n) to cause the subject matter and the functional operations described herein. A memory (e.g., system memory 920) may include a single memory device or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 950 may be configured to coordinate I/O traffic between processors 910a-1010n, system memory 920, network interface 940, I/O devices 960, or other peripheral devices. I/O interface 950 may perform protocol, timing, or other data transformations to convert data signals from one component (e.g., system memory 920) into a format suitable for use by another component (e.g., processors 910a-910n). I/O interface 950 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computing system 900 or multiple computing systems 900 configured to host different portions or instances of embodiments. Multiple computing systems 900 may provide for parallel or sequential processing/execution of one or more portions of the techniques described herein.

Those skilled in the art will appreciate that computing system 900 is merely illustrative and is not intended to limit the scope of the techniques described herein. Computing system 900 may include any combination of devices or software that may perform or otherwise provide for the performance of the techniques described herein. For example, computing system 900 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computing system 900 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computing system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computing system 900 may be transmitted to computing system 900 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computing system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computing system” performing step A and “the computing system” performing step B can include the same computing device within the computing system performing both steps or different computing devices within the computing system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and can be implemented in the form of data that causes functionality to be invoked, e.g., in the form of arguments of a function or API call. To the extent bespoke noun phrases (and other coined terms) are used in the claims and lack a self-evident construction, the definition of such phrases may be recited in the claim itself, in which case, the use of such bespoke noun phrases should not be taken as invitation to impart additional limitations by looking to the specification or extrinsic evidence.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

The present techniques will be better understood with reference to the following enumerated embodiments:
1. A non-transitory, machine-readable medium storing instructions that, when executed by one or more processors, effectuate operations comprising: obtaining, by a computer system, first visual content of a macro-area of a physical environment that includes a micro-area of the physical environment; obtaining, by the computer system, first position information associated with an imaging sensor used to capture the first visual content, wherein the first position information is captured during capturing of the first visual content; determining, by the computer system, a first plurality of feature points in the micro-area of the physical environment captured by the imaging sensor; obtaining, by the computer system, a mapping of a first augmented reality model at a location in the physical environment via a display such that the first augmented reality model is associated with the first plurality of feature points in the micro-area; and storing, by the computer system, the first visual content, the first position information, the first plurality of feature points, the first augmented reality model, and the mapping of the first augmented reality model and the first plurality of feature points in a database.
2. The medium of embodiment 1, wherein the first visual content includes a first image and the first position information includes a first location and a first orientation of the imaging sensor when the first image was captured.
3. The medium of embodiment 2, wherein the first image is added to a first set of images that are each associated with a location that satisfies a location condition.
4. The medium of embodiment 3, wherein the first image is associated with the first orientation that is different from orientations associated with other images in the first set of images.
5. The medium of any one of embodiments 1-4, wherein the first visual content includes video content of the macro-area of the physical environment transitioning to the micro-area of the physical environment.
6. The medium of any one of embodiments 1-5, wherein the operations further comprise: storing, by the computer system, second visual content, second position information a second plurality of feature points, a second augmented reality model, and a mapping of the second augmented reality model and the second plurality of feature points in the database.
7. The medium of embodiment 6, wherein the operations further comprise: linking, by the computer system, the second augmented reality model to the first augmented reality model such that the second visual content only displays on an augmented reality device when that augmented reality devices is at a second position that corresponds with the second position information and has localized at the first plurality of feature points.
8. The medium of any one of embodiments 1-7, wherein the operations comprise steps for: obtaining the first visual content.
9. The medium of any one of embodiments 1-8, wherein the mapping is a result of an alignment of the first augmented reality model in the physical environment displayed on an augmented reality device.
10. The medium of embodiment 9, wherein the alignment is performed using position information obtained by positioning sensors included on the augmented reality device.
11. A non-transitory, machine-readable medium storing instructions that, when executed by one or more processors, effectuate operations comprising: causing, by a computer system and in response to a localization condition being satisfied, visual content of a macro-area of a physical environment that includes a micro-area of the physical environment to be displayed on a display of an augmented reality device; obtaining, by the computer system, a plurality of feature points of the physical environment captured by the augmented reality device; detecting, by the computer system, a set of feature points from the plurality of feature points that indicates a mapped micro-area of the physical environment, wherein the mapped micro-area is associated with an augmented reality model; localizing, by the computer system, the augmented reality device with the mapped micro-area; and causing, by the computer system, the augmented reality model to be displayed in the display of the augmented reality device according to the mapped micro-area of the set of feature points and a location of the augmented reality model mapped to the set of feature points.
12. The medium of embodiment 11, wherein the visual content is being displayed while the plurality of feature points of the physical environment are being captured by the augmented reality device.
13. The medium of any one of embodiments 11-12, wherein the operations further comprise: obtaining, by the computer system, position information of the augmented reality device wherein the localization condition is satisfied when the position information satisfies a position condition.
14. The medium of any one of embodiments 11-13, wherein the visual content includes first video content of the macro-area of the physical environment transitioning to the micro-area of the physical environment, and wherein the first video content is caused to be displayed when location information of the augmented reality device corresponds with location information associated with the first video content.
15. The medium of embodiment 14, wherein the visual content includes second video content of a second macro-area of the physical environment transitioning to a second micro-area of the physical environment, and the location information of the augmented reality device corresponds with second location information associated with the second video content.
16. The medium of embodiment 15, wherein an order of which the first video content and the second video content are presented on the display of the augmented reality device is based on which location associated with the first video content and the second video content is more proximate to a location associated with the augmented reality device.
17. The medium of any one of embodiments 11-16, wherein the visual content includes a first set of images where each image of the first set of images includes a macro-area of the physical environment that includes a micro-area, and wherein the first set of images are displayed in response to a location associated with the first set of images satisfying the localization condition of corresponding with a first location of the augmented reality device.
18. The medium of embodiment 17, wherein a first image of the first set of images is primarily displayed as the visual content when an orientation associated with the first image satisfies an orientation condition with an orientation associated with the augmented reality device.
19. The medium of embodiment 18, wherein a second image of the first set of images is displayed as the visual content when an orientation associated with the second image satisfies an orientation condition with a second orientation associated with the augmented reality device.
20. The medium of embodiment 17, wherein the operations further comprise: causing, by the computer system, to display second visual content that includes a second set of images where each image of the second set of images includes a respective macro-area of the physical environment that includes a respective micro-area of the physical environment, wherein the second set of images are displayed in response to a location associated with the second set of images satisfying the localization condition of corresponding with a second location of the augmented reality device that is subsequent from the first location.
21. A process comprising: the operations of any one of embodiments 1-10.
22. A system, comprising: one or more processors; and memory storing instructions that when executed by the processors cause the processors to effectuate operations comprising: the operations of any one of embodiments 1-10.
23. A process comprising: the operations of any one of embodiments 11-20.
24. A system, comprising: one or more processors; and memory storing instructions that when executed by the processors cause the processors to effectuate operations comprising: the operations of any one of embodiments 11-20.

What is claimed is:

1. A non-transitory, machine-readable medium storing instructions that, when executed by one or more processors, effectuate operations comprising:
obtaining, by a computer system, first visual content of a macro-area of a physical environment that includes a micro-area of the physical environment;
obtaining, by the computer system, first position information associated with an imaging sensor used to capture the first visual content, wherein the first position information is captured during capturing of the first visual content;
determining, by the computer system, a first plurality of feature points in the micro-area of the physical environment captured by the imaging sensor;
obtaining, by the computer system, a mapping of a first augmented reality model at a location in the physical environment via a display such that the first augmented reality model is associated with the first plurality of feature points in the micro-area; and
storing, by the computer system, the first visual content, the first position information, the first plurality of feature points, the first augmented reality model, and the mapping of the first augmented reality model and the first plurality of feature points in a database.

2. The medium of claim 1, wherein the first visual content includes a first image and the first position information includes a first location and a first orientation of the imaging sensor when the first image was captured.

3. The medium of claim 2, wherein the first image is added to a first set of images that are each associated with a location that satisfies a location condition.

4. The medium of claim 3, wherein the first image is associated with the first orientation that is different from orientations associated with other images in the first set of images.

5. The medium of claim 1, wherein the first visual content includes video content of the macro-area of the physical environment transitioning to the micro-area of the physical environment.

6. The medium of claim 1, wherein the operations further comprise:
storing, by the computer system, second visual content, second position information a second plurality of feature points, a second augmented reality model, and a mapping of the second augmented reality model and the second plurality of feature points in the database.

7. The medium of claim 6, wherein the operations further comprise:
linking, by the computer system, the second augmented reality model to the first augmented reality model such that the second visual content only displays on an augmented reality device when that augmented reality devices is at a second position that corresponds with the second position information and has localized at the first plurality of feature points.

8. The medium of claim 1, wherein the operations comprise steps for:
obtaining the first visual content.

9. The medium of claim 1, wherein the mapping is a result of an alignment of the first augmented reality model in the physical environment displayed on an augmented reality device.

10. The medium of claim 9, wherein the alignment is performed using position information obtained by positioning sensors included on the augmented reality device.

11. A non-transitory, machine-readable medium storing instructions that, when executed by one or more processors, effectuate operations comprising:
causing, by a computer system and in response to a localization condition being satisfied, visual content of a macro-area of a physical environment that includes a micro-area of the physical environment to be displayed on a display of an augmented reality device;
obtaining, by the computer system, a plurality of feature points of the physical environment captured by the augmented reality device;
detecting, by the computer system, a set of feature points from the plurality of feature points that indicates a mapped micro-area of the physical environment, wherein the mapped micro-area is associated with an augmented reality model;
localizing, by the computer system, the augmented reality device with the mapped micro-area; and
causing, by the computer system, the augmented reality model to be displayed in the display of the augmented reality device according to the mapped micro-area of the set of feature points and a location of the augmented reality model mapped to the set of feature points.

12. The medium of claim 11, wherein the visual content is being displayed while the plurality of feature points of the physical environment are being captured by the augmented reality device.

13. The medium of claim 11, wherein the operations further comprise:
obtaining, by the computer system, position information of the augmented reality device wherein the localization condition is satisfied when the position information satisfies a position condition.

14. The medium of claim 11, wherein the visual content includes first video content of the macro-area of the physical environment transitioning to the micro-area of the physical environment, and wherein the first video content is caused to be displayed when location information of the augmented reality device corresponds with location information associated with the first video content.

15. The medium of claim 14, wherein the visual content includes second video content of a second macro-area of the physical environment transitioning to a second micro-area of the physical environment, and the location information of the augmented reality device corresponds with second location information associated with the second video content.

16. The medium of claim 15, wherein an order of which the first video content and the second video content are presented on the display of the augmented reality device is based on which location associated with the first video content and the second video content is more proximate to a location associated with the augmented reality device.

17. The medium of claim 11, wherein the visual content includes a first set of images where each image of the first set of images includes a macro-area of the physical environment that includes a micro-area, and wherein the first set of images are displayed in response to a location associated with the first set of images satisfying the localization condition of corresponding with a first location of the augmented reality device.

18. The medium of claim 17, wherein a first image of the first set of images is primarily displayed as the visual content when an orientation associated with the first image satisfies an orientation condition with an orientation associated with the augmented reality device.

19. The medium of claim 18, wherein a second image of the first set of images is displayed as the visual content when an orientation associated with the second image satisfies an orientation condition with a second orientation associated with the augmented reality device.

20. The medium of claim 17, wherein the operations further comprise:
causing, by the computer system, to display second visual content that includes a second set of images where each image of the second set of images includes a respective macro-area of the physical environment that includes a respective micro-area of the physical environment, wherein the second set of images are displayed in response to a location associated with the second set of images satisfying the localization condition of corresponding with a second location of the augmented reality device that is subsequent from the first location.
